(19) United States
(12) Patent Application Publication
(10) Pub. No.: US 2004/0062257 A1
(43) Pub. Date: Apr. 1, 2004

(54) System and method of maintaining coherent and synchronized address tables on all switches in a software stacking configuration

(75) Inventor: Tuan Anh Nguyen, Carlsbad, CA (US)

Correspondence Address: KENYON & KENYON, 1500 K STREET, N.W., SUITE 700, WASHINGTON, DC, 20005, US

(73) Assignee: INTEL CORPORATION

(21) Appl. No.: 10/259,902

(22) Filed: Sep. 30, 2002

(51) Int. Cl. H04L 12/28

(52) U.S. Cl. 370/403

(57) ABSTRACT

Methods and systems provide for identical address tables in a software stack of switches. The software stack is maintained by organizing the switches into the software stack. Each switch in the software has a corresponding address table and one or more ports. Each address table maps one or more packet addresses to a port in the software stack. Synchronization of the address tables is initiated and enables significant performance improvements. Synchronization is initiated by populating a command buffer of a first switch in the stack with one or more address table commands. The buffer is distributed to remaining switches in the stack.

### BACKGROUND

1. Technical Field

Embodiments of the present invention generally relate to computer networking. More particularly, the embodiments relate to the maintenance of software switching stacks in networking architectures.

2. Discussion

In the highly competitive computer industry, there is a well-documented trend toward faster processing speeds and enhanced functionality. While the above trend is desirable to the consumer, it presents significant challenges to computer designers as well as manufacturers. One area of particular concern is networking.

Improving the performance of networking architectures requires consideration and analysis of a number of architecture components such as control logic, terminals and switches. A typical network employs a number of switches, where each switch relays packets between a set of hosts or networks. The switches can be connected in a wide variety of topologies, such as daisy-chain, ring, star, or star-wired matrix. Each switch typically has a number of ports and an address table that maps one or more packet addresses to the ports on the switch. An address table is built by learning the unresolved address from received packets. In the well documented transport control protocol/Internet protocol (TCP/IP) protocol stack, Layers 2, 3 and 4 represent the network, transport, session, presentation and application layers of the Open Systems Interconnection (OSI) standard (ISO/IEC 10731:1994, International Standards Organization). Thus, each address table functions as a look-up table that maps TCP/IP Layer 2/3/4 addresses to switching node ports. Upon receipt of a packet, a switch performs a table lookup on the destination address of the packet in order to determine on which port to forward the packet. In order to simplify the architecture and improve performance, it is common for a number of these switches to be logically “clustered” (or stacked), where the clustered switches cooperate to perform the function of a single large switch. Thus, each switch in the cluster (or stack) needs to keep track of the addresses assigned to each of the ports in the stack in order to simulate the functionality of a larger switch.

While a number of approaches have been developed to maintain the address tables as current as possible, a number of difficulties remain. For example, the conventional approach is to monitor the addresses using a software layer and a protocol such as the simple network management protocol (SNMPv3, Internet Engineering Steering Group—IESG). Under SNMP, the software layer uses a combination of polling statistics and time-out periods to notify the switches of the need to add, delete and modify addresses assigned to the stack. Unfortunately, such an approach can be slow, particularly in the case of unidirectional transmissions. For example, if a switch determines that a local port has encountered a new address, this information must be transferred all the way to the software layer, and back to each of the switches in the stack. The same is true for stale addresses that must be deleted from each of the address tables. In fact, typical time-out periods, which are used to identify stale addresses, can range anywhere from 30 seconds to 5 minutes. As a result, network errors resulting from improper addressing can be undesirably high. FIG. 2 shows a typical method 10 of maintaining a software stack of switches.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a network switching architecture in accordance with one embodiment of the invention;

FIG. 2 is a flowchart of an example of a conventional method of maintaining a software stack of switches;

FIG. 3 is a flowchart of an example of a method of maintaining a software stack of switches in accordance with one embodiment of the invention;

FIG. 4 is a flowchart of an example of a method of initiating synchronization of a plurality of address tables in accordance with one embodiment of the invention;

FIG. 5 is a flowchart of an example of a process of distributing a command buffer in accordance with one embodiment of the invention;

FIG. 6 is a flowchart of an example of a process of populating a command buffer in accordance with one embodiment of the invention; and

FIG. 7 is a flowchart of a method of processing an address table command buffer in accordance with one embodiment of the invention.

### DETAILED DESCRIPTION

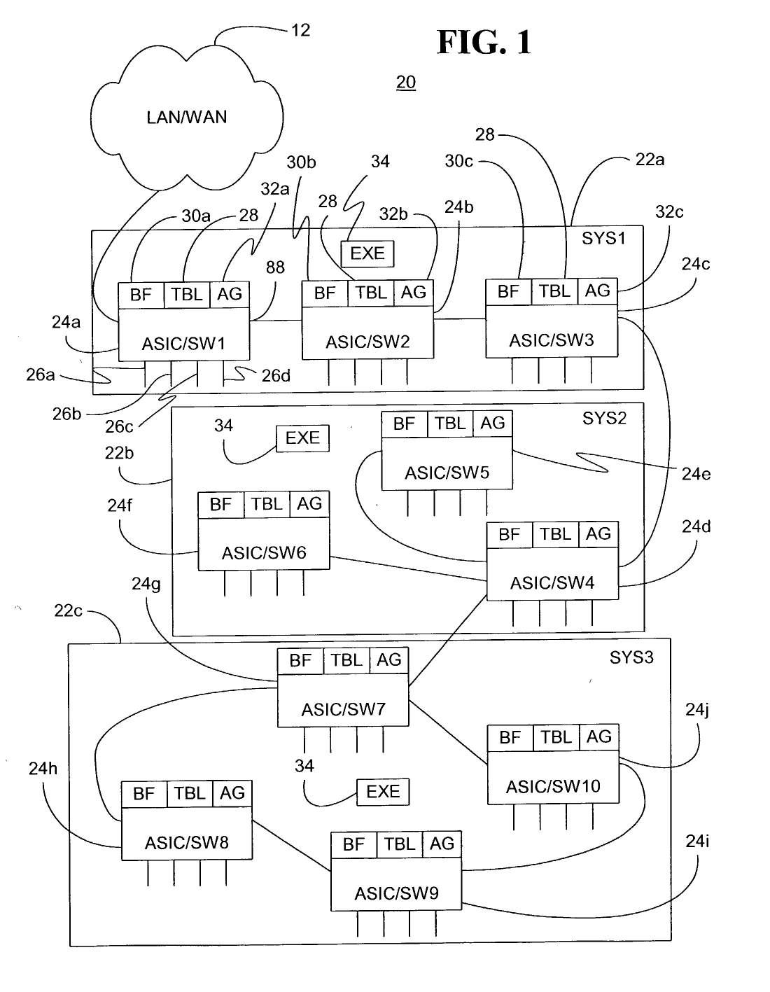

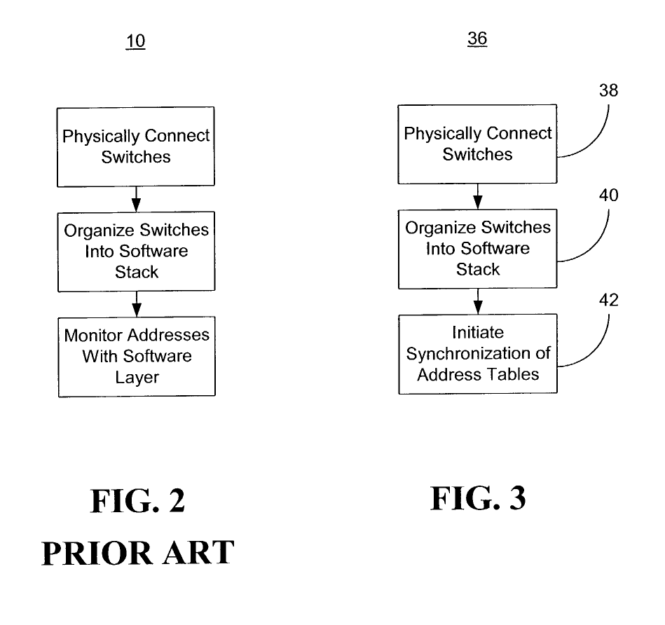

Embodiments of the invention provide for synchronized address tables in a software stack of switches. FIG. 1 shows a network switching architecture 20 having a plurality of systems 22a-22c connected to a local area network (LAN) or wide area network (WAN) 12. The architecture 20 can be used to implement a corporate network having thousands of nodes and terminals. It will therefore be appreciated that the number of systems shown can be readily expanded to meet the needs of the network. The illustrated systems 22a-22c are interconnected through a commercially available Ethernet connection. While the embodiments will be primarily described with regard to corporate networks interconnected via Ethernet systems, it is important to note that the invention is not so limited. In fact, the principles described herein can be beneficial to any networking architecture in which addressing is an issue of concern. Notwithstanding, there are a number of aspects of Ethernet connections as well as corporate networks for which architecture 20 is uniquely suited.

It can be seen that each system 22a-22c has one or more switches 24a-24j, where the switches 24a-24j are commonly implemented in an application specific integrated circuit (ASIC). The switches 24a-24j can be obtained from any number of sources such as the “Intel Media Switch” family of products. The switches 24a-24j can enable a wide variety of services such as true voice, video and data integration over corporate networks. Exemplary applications of the architecture 20 include, but are not limited to, voice over Internet protocol (VoIP, ITU-T H.323, International Telecommunication Union), distance learning, streaming video, teleconferencing and videoconferencing. Multi-service capabilities include quality of service (QoS), class of service (CoS), multicasting, routing, bandwidth management and provisioning. The various silicon hardware and software building blocks of the switches 24a-24j include driver application protocol interfaces and Layer 2 and Layer 3 protocol stacks. The protocol stacks are used to build Layer 2/3/4 switch routers. Application programming interfaces (APIs) include code for all hardware dependent parts.

Each switch 24a-24j generally has one or more ports 26a-26d, wherein the ports 26a-26d typically encounter various Internet protocol (IP) addresses over time. Although the switches 24a-24j are shown as having four ports, it will be appreciated that the number of ports may vary depending upon the circumstances. Indeed, many commercially available switches have as many as twenty-four ports. Each switch 24a-24j also has one or more gigabit ports 88 to provide stacking links to the other switches. In addition, it can be seen that each switch 24a-24j has a corresponding address table 28. Each address table 28 maps one or more packet addresses to a port in the software stack. Thus, if a switch 24a-24j encounters a packet having a destination address, the switch 24a-24j looks the address up in the address table 28 to determine the port where the address is located. As such, each address has a system identifier (ID), a device ID (specifying a switch) and a port ID. As will be discussed in greater detail below, each address table 28 is identical due to a unique synchronization approach described herein.

Remote procedure call (RPC) is a type of protocol that allows a program running on one switch to cause code to be executed on another switch without the programmer needing to explicitly code for it. An RPC protocol is therefore a paradigm for implementing the client-server model of distributed computing. An RPC can be initiated by a caller (e.g., first switch) sending a request message to a remote system (e.g., second switch) to execute a certain procedure using arguments supplied. As illustrated, each switch 24a-24j maintains a database RPC command buffer 30a-30c to queue address operation commands based on events occurring locally at the switch. For example, switch 24a may encounter Address X at port 26a, and therefore may require the addition of Address X to the address table 28. Instead of merely adding Address X to table 28, switch 24a writes an add command (or add command arguments) to buffer 30a. Similarly, switch 24a may determine that a stale address, say Address Y, may be assigned to port 26b. As a result, switch 24a will write a delete command to the buffer 30a in order to account for the stale address. In this regard, it can be seen that each switch 24a-24j has an aging engine 32a-32c, which dynamically ages the addresses assigned to the local ports of the corresponding switch. Address aging is discussed in greater detail below.

Using a synchronization token, the switches 24a-24j take turns distributing their particular command buffer 30a-30c to the other switches in the stack. A database RPC command execution task 34 running on each system 22a-22c executes the commands in the received command buffer. As a result, address table maintenance becomes distributed and a number of speed and reliability advantages are achieved.

With continuing reference to FIGS. 1 and 3, a computer implemented method 36 of maintaining a software stack of switches 24a-24j is shown. Generally, processing block 38 provides for physically connecting the switches 24a-24j with a networking medium such as an Ethernet system. The switches 24a-24j are organized into a software stack at block 40, where each switch in the software stack has a corresponding address table 28 and one or more ports 26a-26d. Each switch 24a-24j is assigned a device identifier, and each device identifier is assigned a stack priority. For example, in the illustrated example switch 24a could be assigned device ID#1, switch 24b could be assigned ID#2, and so on. Furthermore, the switch with the lowest ID number (namely, switch 24a) could be designated as having the highest priority.

As already discussed, each address table 28 maps one or more packet destination addresses to a port in the software stack. Block 42 provides for initiating synchronization of the address tables. Thus, method 36 provides for the formation of the software stack as well as the initialization of address table synchronization. It will be understood that typically one of the switches 24a-24j will be given the responsibility of forming the software stack and beginning the synchronization process. It should be noted that once the synchronization process has begun, each switch 24a-24j will have the opportunity to initiate synchronization as shown in block 42.

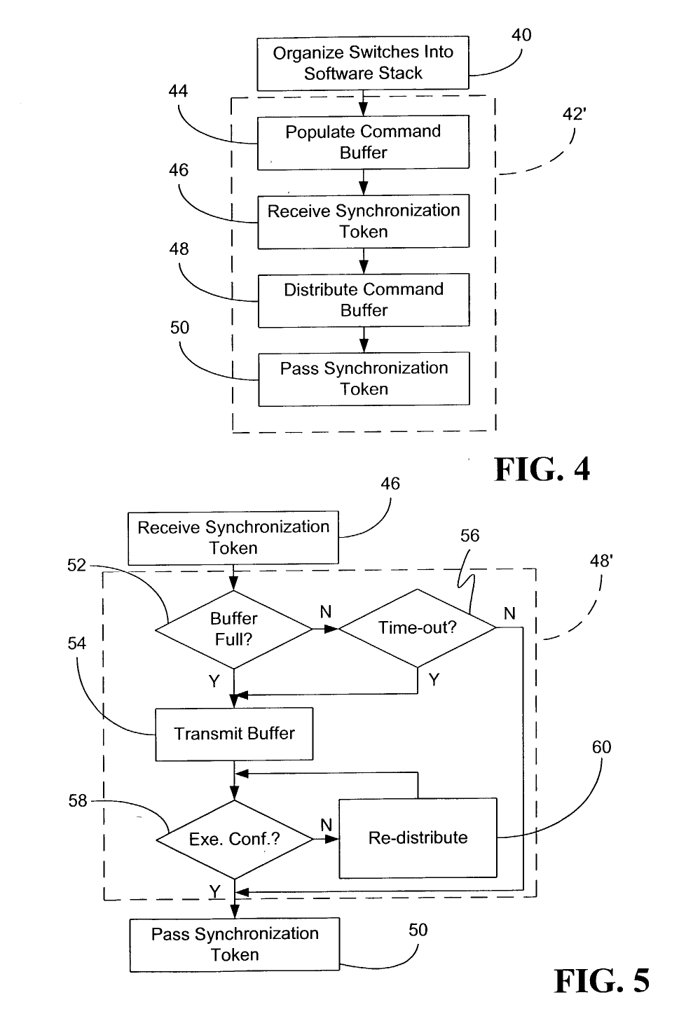

Turning now to FIGS. 1 and 4, one approach to initiating synchronization of the address tables is shown in greater detail at block 42′. As already discussed, any switch 24a-24j in the software stack may implement block 42′, provided the switch is in possession of the synchronization token. To facilitate discussion, processing block 42′ will be discussed with regard to switch 24a of system 22a. Specifically, it can be seen that a command buffer 30a of switch 24a is populated with one or more address table commands at block 44. Processing block 46 provides for receiving the synchronization token. It should be noted that the synchronization token may be received from one of the other switches 24a-24j in the stack, or from an initial installation process. Nevertheless, the command buffer 30a is distributed to the remaining switches in the stack at block 48. Block 50 provides for passing the synchronization token to the next switch in the stack, where the synchronization token enables the next switch to initiate synchronization of the address tables.

Turning now to FIG. 5, one approach to distributing the command buffer is shown in greater detail at processing block 48′. Specifically, it can be seen that it is determined whether the buffer is full at block 52. If so, the buffer is transmitted at block 54 to the remaining switches in the stack. By waiting for the command buffer to fill before distributing it, the approach shown at block 48′ can insure a certain level of efficiency. For example, the buffer size can be selected in order to obtain the desired tradeoff between accuracy and resource depletion. Thus, if the command buffer is too small, the address tables will be extremely accurate, but processing resources may be depleted. On the other hand, if the buffer size is too large, processing resources will not be depleted, but the address tables will be less accurate. The illustrated buffers 30a-30c are capable of holding 10 address table commands.

It will also be appreciated that it may take a relatively long time for a command buffer to fill up. In such case, it may be desirable to distribute the commands that are stored in the buffer before they become too old. Thus, processing block 56 provides for determining whether a predetermined period of time has expired since the buffer was last distributed to the remaining switches (i.e., a time-out check). If so, the buffer is transmitted at block 54 as if it were full. It should also be noted that execution of the commands by the remaining switches is confirmed at block 58. Block 60 provides for re-distributing the buffer if one or more of the commands are not executed by one or more of the remaining switches. This enables block 48′ to account for memory and/or protocol problems in the software stack. Once remote execution of the commands is confirmed, the switch in possession of the tokens executes the commands locally to complete the synchronization.

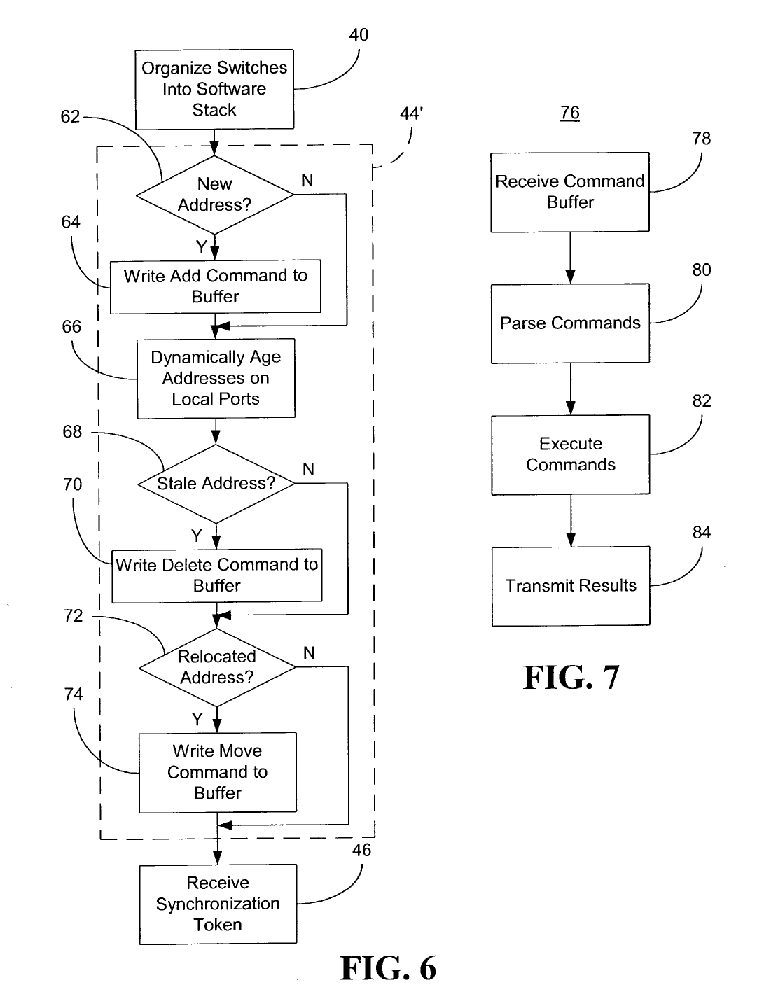

With continuing reference to FIGS. 1 and 6, one approach to populating the command buffer 30a is shown in greater detail at block 44′. Specifically, it can be seen that block 62 provides for determining whether a new address has been encountered at a port of switch 24a. If so, an add command is written to the command buffer at block 64 based on the new address.

As already discussed, each switch 24a-24j dynamically ages the addresses assigned to the local ports of the particular switch. Thus, switch 24a will use aging engine 32a to age the addresses assigned to ports 26a-26d. Address aging is well documented, and limits are typically defined in terms of minutes. The other switches in the software stack “statically” age addresses assigned to remote ports, via the synchronization mechanism discussed herein. Thus, block 66 provides a distributed dynamic/static approach to aging addresses. If a stale address is identified at block 68, block 70 provides for writing a delete command to the command buffer based on the stale address. It can further be seen that block 72 provides for identifying relocated addresses. An address is relocated when it is assigned to one port of a switch and located at another port of the switch. For example, switch 24a may determine that address table 28 indicates that Address X is assigned to port 26a, when in fact, Address X is located at port 26d. In such case, a move command is written to the command buffer based on the relocated address.

It should also be noted that the switches 24a-24j may be arranged in a wide variety of topologies. For example, switches 24a-24c of system 22a are connected in a daisy-chain topology, whereas 24d-24f have a star topology. It can further be seen that switches 24g-24j of system 22c have a ring topology. In any case, the switches 24a-24j are organized into a software stack that effectively defines a logical ring, wherein each switch has a device identifier that falls somewhere within a lowest-to-highest hierarchy. Thus, the device with the lowest identifier may be given the responsibility for forming the software stack and beginning the synchronization process.

With continuing reference to FIGS. 1 and 7, it will be appreciated that a computer-implemented method 76 of processing an address table command buffer 30a-30c is also provided. Method 76 is implemented by all of the switches 24a-24j in the stack not in possession of the synchronization token. Simply put, method 76 enables the switches to synchronize their corresponding address tables with the switch that is currently in possession of the synchronization token. It can be seen that an address table command buffer 30a-30c is received at block 78, and one or more commands are parsed from the buffer 30a-30c at block 80. Block 82 provides for executing the commands, where execution of the commands enables an address table of a corresponding switch to be synchronized with an address table of an initiating switch. Each switch 24a-24j may execute the commands by providing the commands, as well as the corresponding address table 28, to the command execution task 34 associated with the particular switch. It can further be seen that block 84 provides for transmitting results of the execution to the initiating switch.

As already noted, the above systems and methods can be implemented in a number of commercially available products. The embodiments provide for synchronization of address tables of an interconnected group of stackable switching nodes and provides the database feature of a single large switch. It is important to note that implementation can be applied to a number of reliable software stacking topologies such as daisy-chain, ring, star and star-wired-matrix. Conventional approaches cannot support the above-stacking topologies in a strictly software implementation. Furthermore, reliable stacking support can be provided for advanced capabilities such as filtering, priority, quality of service (QoS), IP routing domain, etc., without special hardware systems.

Those skilled in the art can now appreciate from the foregoing description that the broad techniques of the present invention can be implemented in a variety of forms. Therefore, while this invention has been described in connection with particular examples thereof, the true scope of the invention should not be so limited since other modifications will become apparent to the skilled practitioner upon a study of the drawings, specification, and following claims.

What is claimed is:

1. A method of maintaining a software stack of switches, the method comprising:
organizing the switches into a software stack, each switch in the software stack having a corresponding address table and one or more ports, each address table mapping one or more packet addresses to a port in the software stack; and
initiating synchronization of the address tables.

2. The method of claim 1 further including:
populating a command buffer of a first switch in the stack with one or more address table commands; and
distributing the buffer to remaining switches in the stack.

3. The method of claim 2 further including:
confirming execution of the commands by the remaining switches; and
passing a synchronization token to a next switch in the stack, the synchronization token to enable the next switch to initiate synchronization of the address tables.

4. The method of claim 3 further including re-distributing the buffer if one or more of the commands are not executed by one or more of the remaining switches.

5. The method of claim 2 further including:
determining whether the buffer is full; and
distributing the buffer if the buffer is full.

6. The method of claim 2 further including:
determining whether a predetermined period of time has expired since the buffer was last distributed to the remaining switches; and
distributing the buffer if the predetermined period of time has expired.

7. The method of claim 2 further including:
encountering a new address at a port of the first switch; and
writing an add command to the command buffer based on the new address.

8. The method of claim 2 further including:
identifying a stale address assigned to a port of the first switch; and
writing a delete command to the command buffer based on the stale address.

9. The method of claim 8 further including dynamically aging the stale address.

10. The method of claim 2 further including:
identifying a relocated address, the relocated address being assigned to a first port of the first switch and located at a second port of the first switch; and
writing a move command to the command buffer based on the relocated address.

11. The method of claim 1 wherein the switches are application specific integrated circuits (ASICs).

12. The method of claim 1 wherein the switches are physically connected through an Ethernet medium.

13. The method of claim 1 further including organizing switches having a daisy-chain topology.

14. The method of claim 1 further including organizing switches having a star topology.

15. The method of claim 1 further including organizing switches having a ring topology.

16. The method of claim 1 further including:
assigning each switch a device identifier; and
assigning a stack priority to each device identifier.

17. A method of initiating synchronization of a plurality of address tables, each address table corresponding to a switch in a software stack, the method comprising:
populating a command buffer of a first switch in the software stack with one or more address table commands;
receiving a synchronization token; and
distributing the buffer to remaining switches in the software stack in response to receiving the synchronization token.

18. The method of claim 17 further including:
confirming execution of the commands by the remaining switches; and
passing the synchronization token to a next switch in the software stack.

19. The method of claim 18 further including re-distributing the buffer if one or more of the commands are not executed by one or more of the remaining switches.

20. The method of claim 17 further including:
determining whether the buffer is full; and
distributing the buffer if the buffer is full.

21. The method of claim 17 further including:
determining whether a predetermined period of time has expired since the buffer was last distributed to the remaining switches; and
distributing the buffer if the predetermined period of time has expired.

22. A method of processing an address table command buffer, the method comprising:
receiving the buffer;
parsing one or more commands from the buffer; and
executing the commands, execution of the commands to enable an address table of a responding switch to be synchronized with an address table of an initiating switch.

23. The method of claim 22 wherein the switches are part of a software stack, each switch having one or more ports, each address table mapping one or more packet addresses to a port in the software stack.

24. The method of claim 22 further including transmitting results of the execution to the initiating switch.

25. A method of maintaining a software stack of application specific integrated circuits (ASICs), the method comprising:
organizing the ASICs into a software stack by assigning each ASIC a device identifier and assigning a stack priority to each device identifier, each ASIC in the software stack having a corresponding address table and one or more ports, each address table mapping one or more packet addresses to a port in the software stack;
populating a remote procedure call (RPC) command buffer of a first ASIC in the stack with one or more address table commands;
distributing the buffer to remaining ASICs in the stack;
confirming execution of the commands by the remaining ASICs;
re-distributing the buffer if one or more of the commands are not executed by one or more of the remaining switches; and
passing a synchronization token to a next ASIC in the stack, the synchronization token to enable the next ASIC to initiate synchronization of the address tables.

26. The method of claim 25 further including:
determining whether the buffer is full; and
distributing the buffer if the buffer is full.

27. The method of claim 25 further including:
determining whether a predetermined period has expired since the buffer was last distributed; and
distributing the buffer if the predetermined period of time has expired.

28. A machine readable medium storing a set of instructions capable of being executed by a processor to:
populate a command buffer of a first switch in the software stack with one or more address table commands;
receive a synchronization token; and
distribute the buffer to remaining switches in the software stack in response to receiving the synchronization token.

29. The medium of claim 28 wherein the instructions are further capable of being executed by a processor to:
confirm execution of the commands by the remaining switches; and
pass the synchronization token to a next switch in the software stack.
